(19) United States
(12) Patent Application Publication
(10) Pub. No.: US 2012/0286461 A1
(43) Pub. Date: Nov. 15, 2012

(54) CONTROLLED OSCILLATION DAMPER

(75) Inventor: Willy Braun, Neustetten (DE)

(73) Assignee: Robert Bosch GmbH, Stuttgart (DE)

(21) Appl. No.: 13/511,945

(22) PCT Filed: Oct. 7, 2010
(86) PCT No.: PCT/EP2010/064960

§ 371 Date: May 24, 2012

(30) Foreign Application Priority Data
Nov. 25, 2009 (DE) 10 2009 047 111.1

(51) Int. Cl. F16F 15/067

(52) U.S. Cl. 267/137

(57) ABSTRACT

An oscillation reduction system for an electric tool includes a first substance that is arranged on an elastic element. The first substance is configured to reduce housing oscillations by providing a relative motion with respect to a housing of the electric tool. The oscillation reduction system further includes a second substance that can be driven depending on the relative motion of the first substance with respect to the housing. An electric tool includes the oscillation reduction system.

### PRIOR ART

The present invention relates to an oscillation reduction system for an electric tool, having a first mass which is arranged on an elastic element, with the first mass, for the purpose of reducing housing oscillations, being provided for a relative movement in relation to a housing of the electric tool, and the oscillation reduction system comprising a second mass. The present invention also relates to an electric tool having an oscillation reduction system according to the invention.

As a result of the implementation of the statutory requirement, when electric tools are used, to couple the permissible daily workload to the physical load acting upon the operator, the topic of vibrations is becoming increasingly important in electric tools, above all in hammer drills and percussion hammers.

The percussion drilling and chipping with a hammer involve major physical loading on the operator arising from the housing oscillation generated by the percussion mechanism. Specifically in the case of large hammer drills and percussion hammers, the vibrations are very pronounced because of the high striking energy. For operators of such machines, therefore, the permitted work time is sometimes reduced considerably without any further measures. Consequently, development is increasingly concentrated on solutions in which vibrations of electric tools are reduced. It can thereby be ensured that work can also continue to be carried out with these devices without restriction.

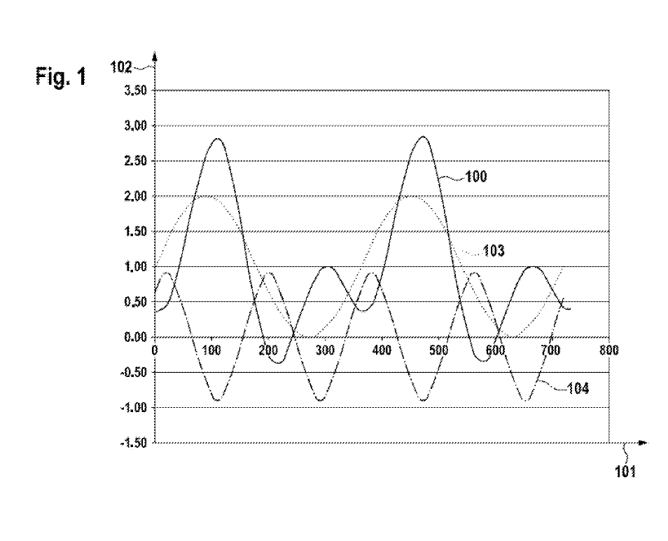

FIG. 1 shows a typical housing oscillation 100 which is produced when the housing of hammer drills and percussion hammers 7 vibrate, this vibration being caused by a percussion mechanism assembly 8 in which the striker 81 is driven by an eccentric piston drive 12. The rotation angle [in °] is plotted on the horizontal axis 101 and the deflection [in mm] of the housing is plotted on the vertical axis 102. The vibration-generating housing oscillation 100 is composed of several frequency components. The main frequency is derived from the periodic acceleration of the striker 81. However, FIG. 1 shows that further frequency components from other vibration sources, for example from the impact and recoil actions of the striking chain and of uncompensated mass forces of the drive, can be superposed on the deflection which is caused by the periodic acceleration of the striker 81. This is because the housing oscillation 100 does not run substantially sinusoidally with the main frequency, but rather further frequency components are superposed on the sinusoidal profile at the main frequency.

Since nonlinear systems act with movement sequences which are harmonic to only a limited extent, the individual vibration components are superposed on one another in a complex manner. Play between the individual components, non-linear elasticity profiles, the non-linear impact actions and the only approximately harmonic reaction forces from the percussion mechanism give rise to non-harmonic housing oscillations of complex order.

An optimum reduction in the housing oscillation is achieved when an oscillation reduction system counteracts the housing oscillation illustrated in FIG. 1 as exactly as possible.

In practice, the counteracting forces which counteract the housing vibrations are generated, for example, with the aid of dampers.

A damper is a spring-mass system with a defined resonant frequency with which a significant oscillation reduction can be achieved only in a small range close to the resonant frequency.

The spring stiffness of a damper is selected, as far as possible, such that the resulting natural frequency of the damper is in the vicinity of the highest interfering vibration frequency of the housing. A disadvantage of this is that the oscillation damping acts effectively only in a relatively narrow frequency range, depending on the size and damping of the damper and the ratio of the damper mass to the device mass. An increase in the oscillation amplitudes may even arise outside said range of action.

It is also known to use a plurality of dampers in order to cover a wider frequency range and to amplify the damping action.

EP 1 415 768 A1 discloses an oscillation damper for an electric tool, which vibration damper comprises at least one mass which can move in at least one direction in space. The mass is arranged on a spring, the spring constant of this spring being matched to the oscillations of the tool in the direction in space.

Active damper systems are also known in order to better match the damper frequency to the main vibration frequency. For example, in electric tools with a percussion mechanism assembly, the main vibration frequency is the striking frequency of the percussion mechanism. In this case, the oscillation dampers are additionally driven by the eccentric drive or, as disclosed in EP 1 464 499 A1, by a pressure difference which is caused by the percussion mechanism.

However, the oscillation dampers known to date share the common feature that their spring-mass systems are effectively active only in their limited frequency range.

### DISCLOSURE OF THE INVENTION

The object of the invention is to provide an oscillation reduction system of which the range of action is increased so that a housing oscillation of an electric tool can be effectively reduced by the oscillation reduction system, and which is of highly compact construction, so that it can be integrated in the electric tool in a space-saving manner. A further object of the invention is to provide an electric tool having an oscillation reduction system of this kind.

This object is achieved by an oscillation reduction system for an electric tool, having a first mass which is arranged on an elastic element, with the first mass for reducing housing oscillations being provided for a relative movement in relation to a housing of the electric tool, with the oscillation reduction system comprising a second mass, it being possible to control the second mass as a function of the relative movement of the first mass in relation to the housing.

A housing oscillation can be compensated by generating counteracting forces of the same magnitude and the same direction of action. Since, according to the invention, the second mass can be controlled as a function of the relative movement of the first mass in relation to the housing, the magnitude and/or the direction of the second mass can be adjusted such that the sum of the counteracting forces which are generated by means of the first mass and the second mass more effectively reduce or even substantially compensate the housing oscillation.

In this case, the amplitude, frequency and/or phase angle of the second mass preferably differ from the amplitude, frequency and/or phase angle of the first mass. The first mass therefore executes a first counter-oscillation and the second mass therefore executes a second counter-oscillation, these counter-oscillations differing from one another. The range of action of the oscillation reduction system according to the invention having the first and the second mass is therefore increased in relation to the range of action of an oscillation reduction system having a single mass.

In particular, the housing oscillation can be approximated with a high degree of accuracy by superposing an, in particular, phase-shifted, higher-frequency oscillation, in particular of a different magnitude, for example of the second mass, onto a low-frequency oscillation, for example of the first mass, and therefore the counteracting forces which are generated by means of the first and second masses can compensate the housing oscillation in a highly effective manner. Therefore, the second mass is preferably provided for a relative movement in relation to a housing and/or the first mass.

Therefore, the oscillation reduction system according to the invention can not only compensate an oscillation which is caused by a unifrequent, cyclical movement of a component, in particular of a striker of a percussion mechanism assembly, but multifrequent housing oscillations can also be compensated by the oscillation reduction system according to the invention by virtue of the superposition of oscillations of further frequency components on the oscillation at the fundamental frequency, said multifrequent housing oscillations being caused, in particular, by further oscillation sources, for example impact or recoil actions of a striking chain, by play between components, by non-linear elasticity profiles, by only approximately harmonic reaction forces of the percussion mechanism or by uncompensated mass forces of the drive.

In this case, multifrequent means, for the purposes of the invention, an oscillation which can be broken down by Fourier analysis into a sinusoidal oscillation with a fundamental frequency and at least one upper harmonic, whereas a unifrequent oscillation can be broken down by Fourier analysis into a sinusoidal oscillation which oscillates at the fundamental frequency.

The elastic element preferably extends substantially in a main direction of action of a vibration source which critically causes the housing oscillation. A vibration source of this kind which critically causes the housing oscillation is, for example, a percussion mechanism assembly, for example, of a percussion hammer, with the main direction of action then being the striking direction of the percussion mechanism assembly.

The first mass preferably executes a substantially linear movement, so that the first mass acts in a first direction of action.

The oscillation reduction system, in particular the first mass, further preferably has a limiting means with which the movement of the second mass, in particular its magnitude and/or its direction, can be limited. A limiting means of this kind is preferably a border or a slotted guide. If the first mass exhibits the limiting means, said limiting means is preferably a border arrangement which delimits an interior space in which the second mass is arranged.

The second mass preferably also executes a substantially linear movement, so that the second mass acts in a second direction of action.

The first direction of action is preferably arranged at an angle to the second direction of action. As a result, housing oscillations which act in different directions of action can also be compensated by an oscillation reduction system according to the invention.

At least the first mass or the second mass particularly preferably acts in and against the main direction of action of the vibration source which critically causes the housing oscillation. As a result, at least the first mass or the second mass at least partially compensates the critical housing oscillation.

The first and the second mass likewise preferably act in or against the main direction of action. In this case, the profile of the counter-oscillations of the two masses can be highly effectively matched to the profile of the housing oscillation which is caused by the critical vibration source, so that said housing oscillation can be highly effectively compensated. The oscillation reduction system can also be produced to be highly compact.

The oscillation reduction system preferably comprises a coupling component which interacts with a mating coupling component of the second mass such that the movement of the first mass is converted into the substantially linear movement of the second mass. The coupling component is preferably coupled to the mating coupling component in an interlocking and/or force-fitting manner. An oscillation reduction system according to the invention can therefore be realized by a large number of embodiments.

The coupling component is preferably a guide means, with the mating coupling component likewise preferably being a receiving means, or vice versa. Interaction between the guide means and the receiving means ensures that the movement is transmitted.

The receiving means is preferably in the form of a groove, recess, web or clearance. The guide means is further preferably in the form of a cam, peg, bolt, protrusion or web. The lists for both the receiving means and for the guide means are not exhaustive. Rather, other coupling components and mating coupling components which ensure that a movement is reliably transmitted in the event of interaction can be used.

In order to improve the sliding and rolling relationships between the guide means and the receiving means, the guide means and/or the receiving means are/is preferably provided with a rotation means, for example a sleeve, a wheel or a rotatable bearing.

In a preferred embodiment, the second mass is positively driven. As a result, the movement between the first mass and the second mass is clearly transmitted even with high reaction forces and a high operating frequency. No additional contact-pressure means, for example springs, are required either. In addition, no energy, which is required for the contact-pressure force or on account of friction and additional wear effects, has to be provided by the motor power.

The oscillation reduction system preferably comprises at least a first gear mechanism component which interacts with the coupling component. The first gear mechanism component has the effect that the relative movement of the first mass in relation to the housing is converted into a substantially linear movement of the second mass. A person skilled in the art will understand that the number of gear mechanism components of the oscillation reduction system is variable. Therefore, in a preferred embodiment, the coupling component is arranged on the first gear mechanism component or interacts directly with the first gear mechanism component, or, in a further preferred embodiment, one or more further gear mechanism components are provided which interact with the first gear mechanism component and the coupling component, so that the first gear mechanism component interacts indirectly with the coupling component.

The first gear mechanism component is preferably mounted on the first mass, so that the oscillation reduction system is of highly compact construction. At least some of the further gear mechanism components are further preferably also mounted on the first mass in order to save installation space.

The first gear mechanism component preferably comprises a connecting means, and the housing preferably comprises a mating connecting means which corresponds to the connecting means, said connecting means and mating connecting means interacting so that the first gear mechanism component executes a movement which corresponds to the relative movement between the first mass and the housing. A tooth system and a mating tooth system are preferred as the connecting means and the mating connecting means since said tooth system and mating tooth system ensure reliable transmission of movement and can be produced in a simple and cost-effective manner. A person skilled in the art will understand that other connecting means, which ensure an interlocking and/or force-fitting transmission of movement in particular, can be used, for example a connection by means of a cam or a groove.

The first gear mechanism component is particularly preferably rotatably mounted on the first mass, so that the movement of the first gear mechanism component, which movement corresponds to the relative movement between the first mass, is a rotary movement about a gear mechanism component axis. A person skilled in the art will understand that gear mechanism components which execute a complete revolution about their gear mechanism component axis can be used, or that gear mechanism components which execute a partial revolution about their gear mechanism component axis can also be used.

If the housing oscillates cyclically in and against a main direction of action on account of a cyclical back and forth movement of a critical vibration source, the relative movement between the first mass and the housing oscillation is also a movement which oscillates cyclically in and against the main direction of action. A person skilled in the art will understand that the cyclical relative movement can be converted both into a harmonic and therefore unifrequent oscillation of the second mass and also into a non-harmonic and therefore multifrequent oscillation of the second mass by virtue of the design and arrangement of the first gear mechanism component and also of further gear mechanism components and of the coupling component and also of the mating coupling component. At least one gear mechanism component, the coupling component and/or the mating coupling component preferably have/has a contour which is curved, in particular. Adapting the contour, in particular its gradient, therefore both allows the second mass to move such that it oscillates back and forth several times and also allows rest points of the movement. A contour of this kind also allows the movement of the compensating mass to be accelerated and impact actions to be executed with the second mass. The contour likewise allows forward and backward movements of the second mass to be extended in respect of time. Therefore, both phase-shifted housing oscillations and acceleration and impact actions, which are caused by a percussion mechanism assembly for example, can be highly effectively compensated.

In a further preferred embodiment, a control means is provided for the purpose of controlling the relative movement of the second mass in relation to the first mass and/or the housing, said control means interacting with the second mass in a force-fitting and/or interlocking manner. The control means allows the movement of the second mass to be dynamically adapted, even during operation, to the actual operating state of the electric tool in which the oscillation reduction system is provided. As an alternative or in addition, the control means also allows the second mass to be controlled independently of the operating point of the electric tool.

The control means can preferably be electrically controlled, in particular as a function of operationally relevant variables or independently of operationally relevant variables. In this case, operationally relevant variables are, for example, the housing oscillation, the rotation speed and/or the rotation angle of the drive motor of the electric tool, variables of the machine which can be adjusted by an operator, or others. As an alternative or in addition, the oscillation of the first mass, in particular its frequency, can preferably be taken into account as an operationally relevant variable, in particular in order to avoid an increase in the oscillation amplitudes if the effective frequency range of the first mass is exceeded.

A person skilled in the art will understand that, in order to take into account operationally relevant variables, it is necessary to detect the operationally relevant variables, for example by means of a sensor. Control or, in particular, adaptive regulation of the control means is possible, for example, by means of a microprocessor-based unit after the operationally relevant variable is detected and evaluated. However, said unit can also be in the form of an electrical circuit, in particular an integrated circuit, for example in the form of an ASIC (Application Specific Integrated Circuit).

In a preferred embodiment, the control means is a pin which is intended to engage in one or more recesses in the second mass. In this embodiment, the control means makes it possible to stop the movement of the second mass. The second mass is further preferably coupled to the first mass in a rest phase of this kind, so that it executes a relative movement in relation to the housing together with the first mass.

The object is also achieved by an electric tool having an oscillation reduction system according to the invention. The oscillation reduction system allows highly effective reduction of the housing oscillation of the electric tool.

The elastic element is preferably mounted on the housing of the electric tool. As a result, a single first gear mechanism component which is mounted on the first mass allows detection of the relative movement of the first mass in relation to the housing.

The invention will be described below with reference to figures. The figures are merely exemplary and do not restrict the general concept of the invention.

FIG. 1 shows a housing oscillation of an electric tool,

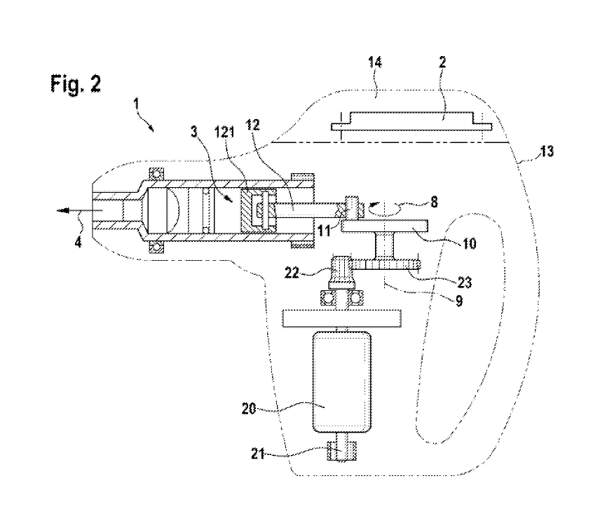

FIG. 2 schematically shows an electric tool having an oscillation reduction system according to the invention,

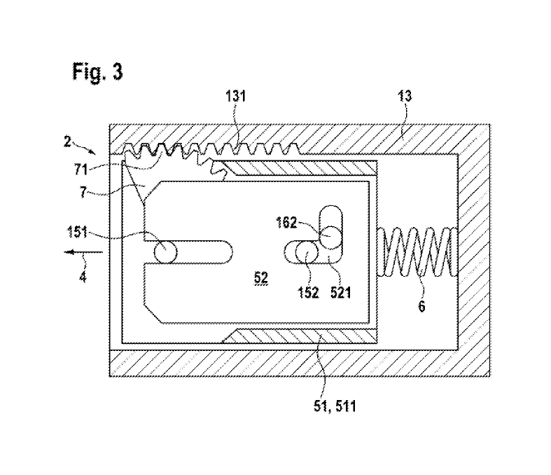

FIG. 3 schematically shows an embodiment of an oscillation reduction system according to the invention,

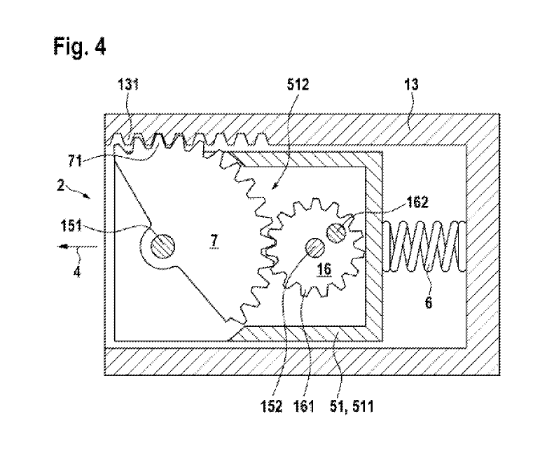

FIG. 4 shows a detail of the oscillation reduction system of FIG. 3, and

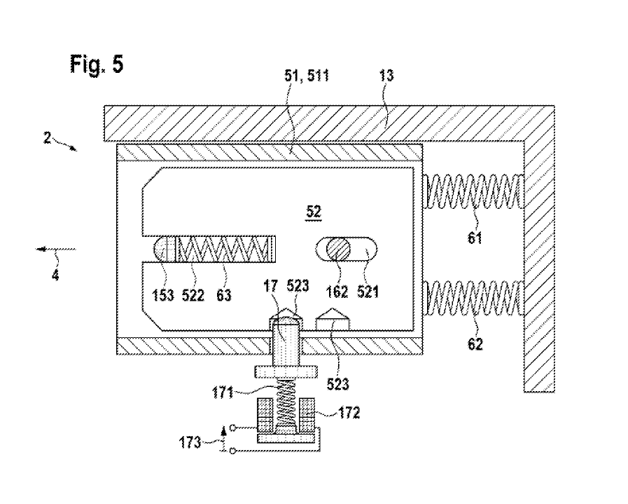

FIG. 5 schematically shows a further embodiment of an oscillation reduction system according to the invention.

FIG. 1 shows, as already described above, a housing oscillation 100 of an electric tool 1. FIG. 1 also shows, by way of example, two sinusoidal oscillations 103, 104 which, when they are superposed on one another, produce the housing oscillation 100. By way of example, the first of the two sinusoidal oscillations 103 is executed by a first mass 51 and the second of the two sinusoidal oscillations 104 is executed by a second mass 52 of an oscillation reduction system 2 according to the invention. As a result, the housing oscillation 100 can compensated.

FIG. 2 schematically shows an electric tool 1 having an oscillation reduction system 2 according to the invention.

In this case, a hammer drill is shown as the electric tool 1 by way of example, said hammer drill comprising a percussion mechanism assembly 3. A percussion mechanism assembly 3 is a vibration source which critically determines the housing oscillation 100. In the text which follows, the term ‘hammer drill’ is used synonymously for the electric tool 1.

A striker 121 is provided in the percussion mechanism assembly 3, said striker being driven in a linear manner by means of a connecting rod 12 which is mounted eccentrically on an eccentric disk 10 by means of an eccentric pin 11, said eccentric disk rotating about an eccentric axis 9.

The eccentric disk 10 can be driven by means of a gear wheel 23 which can likewise be rotated about the eccentric axis 9 and which engages with a drive pinion 22 which is arranged in a rotationally fixed manner on a drive shaft 21 of a drive motor 20 of the electric tool 1.

When the eccentric disk 10 rotates in a rotation direction 8 about the eccentric axis 9, the striker 121 of the percussion mechanism assembly 3 is moved back and forth in a striking direction 4. The striking direction 4 is therefore the main direction of action of the percussion mechanism assembly 3. Therefore, the terms ‘striking direction 4’ and ‘main direction of action’ are used synonymously in the text which follows.

However, the present invention is not restricted to electric tools 1 having a percussion mechanism assembly 3, but can also be used for other electric tools 1, for example on drills, jigsaws or the like, which comprise another or no vibration source which critically causes the housing oscillation 100.

The hammer drill 1 has a cover assembly 14 in which an oscillation reduction system 2 according to the invention is arranged. The oscillation reduction system 2 has the task of reducing or even compensating vibrations of a housing 13 of the hammer drill 1. The housing vibrations 100 are caused, for example, by the percussion mechanism assembly 3 but also by other vibration sources, for example from the impact and recoil actions of a striking chain or by uncompensated mass forces of a drive.

FIG. 3 schematically shows a first embodiment of an oscillation reduction system 2 according to the invention.

The oscillation reduction system 2 has a first mass 51 which is arranged on an elastic element 6, in this case a helical spring. The elastic element 6 is mounted on the housing 13 of the electric tool 1 and extends substantially along the striking direction 4 of the percussion mechanism assembly 3 (see FIG. 2). When the housing 13 vibrates, the first mass 51 is therefore stimulated to carry out a first oscillation 103, with the first mass 51 moving in or against the striking direction 4 of the percussion mechanism assembly 3 (see FIG. 2). The first oscillation 103 of the first mass 51 is delayed with respect to the housing oscillation 100 due to the inertia of the first mass 51. There is therefore a relative movement between the first mass 51 and the housing 13.

A first gear mechanism component 7, which has a connecting means 71, in this case a tooth system, is mounted on the first mass 51. Therefore, the terms ‘connecting means 71’ and ‘tooth system’ are used synonymously in the descriptions of FIG. 3 and FIG. 4.

A mating connecting means 131, in this case a mating tooth system, which corresponds to the connecting means 71 is arranged on the housing 13. Therefore, the terms ‘mating connecting means 131’ and ‘mating tooth system’ are used synonymously in the descriptions of FIG. 3 and FIG. 4.

The first gear mechanism component 7 is arranged on the first mass 51 such that the tooth system 71 of the transmission means 7 engages with the mating tooth system 131 of the housing 13.

In this case, the first gear mechanism component 7 is formed from a first spur gear which is mounted such that it can rotate about a first rotation axis 151 which runs transverse to the striking direction 4 of the percussion mechanism assembly 3 (see FIG. 2) in this case. Therefore, the terms ‘first gear mechanism component 7’ and ‘first spur gear’ are used synonymously in the descriptions of FIG. 3 and FIG. 4.

FIG. 4 shows a detail of the oscillation reduction system 2 of FIG. 3. Said figure shows that the tooth system 71 of the first spur gear 7 engages with a second tooth system 161 of a second gear mechanism component 16, in this case a second spur gear, which is likewise arranged on the first mass 51. Therefore, the terms ‘second gear mechanism component 16’ and ‘second spur gear’ are used synonymously in the descriptions of FIG. 3 and FIG. 4.

The second spur gear 16 is mounted such that it can rotate about a second rotation axis 152 which runs substantially parallel to the first rotation axis 151.

A coupling component 162, in this case a peg, which is eccentrically arranged such that it can rotate about the second rotation axis 152, is provided on the second spur gear 16. Therefore, the terms ‘coupling component 162’ and ‘peg’ are used synonymously in the descriptions of FIG. 3 and FIG. 4.

FIG. 3 shows a second mass 52 of the oscillation reduction system 2 which is arranged on that side of the first spur gear 7 and of the second spur gear 16 which is averted from the first mass 51. A clearance into which the peg 162 engages is provided in the second mass 52 as the mating coupling component 521 which corresponds to the peg 162 of the second spur gear 16. Therefore, the terms ‘mating coupling component 521’ and ‘clearance’ are used synonymously in the descriptions of FIG. 3 and FIG. 4.

Since the tooth system 71 of the first spur gear 7 engages with the mating tooth system 131 of the housing 13, the tooth system 7 and the mating tooth system 131 interengage in the event of a relative movement of the first mass 51 in relation to the housing 13, so that the first spur gear 7 rotates about the first rotation axis 151. The tooth system 71 of the first spur gear 7 also engages with the second tooth system 161 of the second spur gear 16, so that the tooth system 71 and the second tooth system 161 likewise interengage when the first spur gear 7 rotates. In this case, the second spur gear 16 is rotated about the second rotation axis 152, so that the peg 162 rotates eccentrically about the second rotation axis 152.

The peg 162 is arranged in the clearance 521 in the second mass 52 such that the second mass 52 is carried along when the peg 162 rotates about the second rotation axis 152. The second mass 52 is moved back and forth in the striking direction 4 of the percussion mechanism assembly 3 (see FIG. 2) as a result. The peg 162 therefore connects the first spur gear 7 to the second mass 52 such that the second mass 52 moves in a substantially linear manner. The second mass 52 therefore moves relative to the first mass 51 and/or the housing 13.

In order to connect the second mass 52 to the first gear mechanism component 7, so that the rotation of the first gear mechanism component 7 is converted into a substantially linearly running movement of the second mass 52, it is also preferred to arrange the coupling component 162 directly on the first gear mechanism component 7, that is to say the first spur gear 7. It is further preferred for the coupling component 162 to be designed as a cam or as a groove, with, for example, a peg which is arranged on the second mass 52 being used as the mating coupling component 521, in order to be guided along the cam or in order to engage in the groove and to be guided in said groove.

Both the first mass 51 and the second mass 52 extend in a substantially flat manner. As a result, it is possible for the first gear mechanism component 7 and further gear mechanism components 16 to be arranged in the region of the first mass 51. In this case, the second mass 52 is preferably likewise arranged in the region of the first mass 51, specifically on that side of the gear mechanism component or components 7, 16 which is averted from the first mass 51. The first and the second mass 51, 52 preferably extend substantially parallel to one another. Therefore, the oscillation reduction system 2 can be produced to be very flat and can be matched very effectively to the installation conditions.

The movement of the first mass 51 is preferably limited by the housing 13 of the electric tool 1. The first mass 51 and/or the housing 13 of the electric tool 1 likewise preferably limit/limits the movement of the second mass 52. In a preferred embodiment, the first mass 51 has a limiting means 511, in this case a border arrangement 511, which delimits an interior space 512 (see FIG. 4). In this case, the second mass 52 and the gear mechanism components 7, 16 are arranged in the interior space in the first mass 52, so that the border arrangement 511 of the first mass 51 limits the movement of the second mass 52.

Other coupling and mating coupling components 162, 521 are also feasible, these ensuring that the movement of the first gear mechanism component 7 is converted into the desired, in particular substantially linear, movement of the second mass 52.

In this case, the movement sequence of the second mass 52 depends on the design and number of gear mechanism components 7, 16, the design of the coupling and/or mating coupling components 162, 521 and/or their eccentricity. In particular, the design of at least one of the gear mechanism components 7, 16 of the coupling component 162 and/or the mating coupling component 521 has a contour, in particular a curved contour, so that the movement of the second mass 52 runs in a harmonic or non-harmonic manner. In the case of a non-harmonic movement of the second mass 52, said movement comprises accelerations and/or rest phases for example.

A person skilled in the art will understand that the linear movement of the second mass 52 is also possible in a direction which runs at an angle to the striking direction 4. It is also feasible for the first mass 51 to not be moved back and forth in the striking direction 4 but rather in a direction which runs at an angle to the striking direction 4.

FIG. 5 schematically shows a further embodiment of an oscillation reduction system 2 according to the invention.

In this embodiment, the first mass 51 is mounted on the housing 13 of the electric tool 1 by means of a first elastic element 61 and a second elastic element 62. The first and the second elastic element 61, 62 also extend substantially in the striking direction 4 of the percussion mechanism assembly 3 (see FIG. 2), so that the first mass 51 is provided for an oscillation which runs in and against the striking direction 4. In this case, the second mass 52 is also arranged in an interior space 512 in the first mass 51, said interior space being delimited by a border arrangement 511 of the first mass 51.

Furthermore, this embodiment of the oscillation reduction system 2 provides the peg as the coupling component 162 and the clearance as the mating coupling component 521.

However, the oscillation of the second mass 52 is limited by a further limiting means 153, in this case a bolt, which engages in a clearance 522 in the second mass 52. Therefore, the term ‘bolt’ is used synonymously for the further limiting means 153 in the text which follows. A limiting spring 63 is provided in the clearance 522, said limiting spring bearing against the bolt 153 and preventing the second mass 52 striking the bolt 153.

In contrast to the embodiment of FIGS. 3 and 4, an electrically controllable control means 17, in this case in the form of a pin, is provided in the embodiment illustrated here. Therefore, the term ‘pin’ is used synonymously for the electrically controllable control means 17 in the text which follows. The pin 17 is intended to engage in recesses in the second mass and allows the movement of the second mass 52 in relation to the first mass 51 to be stopped. In this embodiment, it also allows the second mass 52 to be coupled to the first mass 51, so that the two masses 52, 51 oscillate together. This changes the amplitude, the frequency and/or the phase angle of the oscillation reduction system 2.

In the embodiment shown here, the pin 17 can be electrically controlled by a magnetic pushbutton 171, on which the pin 17 is arranged, being moved by means of a solenoid 172, so that the pin 17 can be moved back and forth from a position in which it engages in one of the recesses 523 in the second mass 52 to a position in which it does not engage in one of the recesses 523 in the second mass 52. A solenoid 172 with a pushbutton 171 of this kind can be realized, for example, by means of a conventional relay and therefore in a highly cost-effective and space-saving manner.

The solenoid 172 or the relay requires an actuation signal 173 for this purpose, it being possible for said actuation signal to be generated by an, in particular microprocessor-based, control arrangement (not illustrated here) which is integrated in the electric tool 1.

In this embodiment, the movement of the first mass 51 and the housing 13 is detected by means of detection means (not illustrated here), and their relative movement in relation to one another forms the basis of the actuation signal 173.

A person skilled in the art will understand that the embodiments of FIGS. 3, 4 and FIG. 5 can be combined, so that the second mass 52 can be controlled both by means of a first gear mechanism component 7 and by means of a control means 17.

1. An oscillation reduction system (2) for an electric tool comprising:
a first mass which is arranged on an elastic element the first mass being configured to reduce housing oscillations by providing a relative movement in relation to a housing of the electric tool, and
a second mass can configured to be controlled as a function of the relative movement of the first mass in relation to the housing.

2. The oscillation reduction system as claimed in claim 1, wherein the elastic element extends substantially in a main direction of action of a vibration source which primarily causes the housing oscillation.

3. The oscillation reduction system as claimed in claim 1, wherein the first mass executes a substantially linear movement.

4. The oscillation reduction system as claimed in claim 1, wherein the first mass has a limiting member that limits one or more of a magnitude and a direction of movement of the second mass.

5. The oscillation reduction system as claimed in claim 1, wherein the second mass executes a substantially linear movement.

6. The oscillation reduction system as claimed in claim 5, it comprises further comprising a coupling component which interacts with a mating coupling component of the second mass such that the movement of the first mass is converted into the substantially linear movement of the second mass.

7. The oscillation reduction system as claimed in claim 1, wherein the second mass is positively driven.

8. The oscillation reduction system as claimed in claim 6, further comprising at least a first gear mechanism component which interacts with the coupling component.

9. The oscillation reduction system as claimed in claim 8, wherein the first gear mechanism component is, rotatably mounted on the first mass.

10. The oscillation reduction system as claimed in claim 8, wherein the first gear mechanism component includes a connecting member, and the housing includes a mating connecting member which corresponds to the connecting member, the connecting member and mating connecting member interacting so that the first gear mechanism component executes a movement which corresponds to the relative movement between the first mass and the housing.

11. The oscillation reduction system as claimed in claim 1, further comprising a control member that is configured to control a relative movement of the second mass in relation to one or more of the first mass and/or the housing, the control member interacting with the second mass in one or more of a force-fitting and interlocking manner.

12. The oscillation reduction system as claimed in claim 11, wherein the control member can be electrically controlled.

13. The oscillation reduction system as claimed in claim 11, wherein the control member is a pin which is intended to engage in one or more recesses in the second mass.

14. An electric tool including an oscillation reduction system, the oscillation reduction system comprising:
a first mass which is arranged on an elastic element, the first mass being configured to reduce housing oscillations by providing a relative movement in relation to a housing of the electric tool, and
a second mass configured to be controlled as a function of the relative movement of the first mass in relation to the housing.

15. The electric tool as claimed in claim 14, wherein the elastic element is mounted on the housing of the electric tool.
